(19) United States
(12) Patent Application Publication
(10) Pub. No.: US 2014/0368505 A1
(43) Pub. Date: Dec. 18, 2014

(54) GRAPHICS PROCESSING SUBSYSTEM FOR RECOVERING PROJECTION PARAMETERS FOR RENDERING EFFECTS AND METHOD OF USE THEREOF

(71) Applicant: Nvidia Corporation, Santa Clara, CA (US)

(72) Inventors: Louis Bavoil, Courbevoie (FR); Miguel Sainz, Theale (GB); Byungmoon Kim, Sunnyvale, CA (US)

(21) Appl. No.: 13/917,406

(22) Filed: Jun. 13, 2013

(51) Int. Cl. G06T 15/80

(52) U.S. Cl. CPC G06T 15/80
USPC 345/426

(57) ABSTRACT

A graphics processing subsystem for recovering projection parameters for rendering effects and a method of use thereof. One embodiment of the graphics processing subsystem includes: (1) a memory configured to store a buffer having a plurality of constants determinable upon execution of an application for which a scene is rendered, and (2) a central processing unit (CPU) operable to determine projection parameters from the buffer according to shader-reflection metadata attached to a programmable shader submitted for execution, and employ the projection parameters to cause an effect to be rendered on the scene by a graphics processing unit (GPU).

### TECHNICAL FIELD

This application is directed, in general, to computer graphics and, more specifically, to recovering projection parameters necessary for rendering effects in three-dimensional space.

### BACKGROUND

Many computer graphic images are created by mathematically modeling the interaction of light with a three dimensional scene from a given viewpoint. This process, called “rendering,” generates a two-dimensional image of the scene from the given viewpoint, and is analogous to taking a photograph of a real-world scene.

As the demand for computer graphics, and in particular for real-time computer graphics, has increased, computer systems with graphics processing subsystems adapted to accelerate the rendering process have become widespread. In these computer systems, the rendering process is divided between a computer's general purpose central processing unit (CPU) and the graphics processing subsystem, architecturally centered about a graphics processing unit (GPU). Typically, the CPU performs high-level operations, such as determining the position, motion, and collision of objects in a given scene. From these high level operations, the CPU generates a set of rendering commands and data defining the desired rendered image or images. For example, rendering commands and data can define scene geometry, lighting, shading, texturing, motion, and/or camera parameters for a scene. The graphics processing subsystem creates one or more rendered images from the set of rendering commands and data.

Scene geometry is typically represented by geometric primitives, such as points, lines, polygons (for example, triangles and quadrilaterals), and curved surfaces, defined by one or more two- or three-dimensional vertices. Each vertex may have additional scalar or vector attributes used to determine qualities such as the color, transparency, lighting, shading, and animation of the vertex and its associated geometric primitives.

Many graphics processing subsystems are highly programmable through an application programming interface (API), enabling complicated lighting and shading algorithms, among other things, to be implemented. To exploit this programmability, applications can include one or more graphics processing subsystem programs, which are executed by the graphics processing subsystem in parallel with a main program executed by the CPU. Although not confined merely to implementing shading and lighting algorithms, these graphics processing subsystem programs are often referred to as “shading programs,” “programmable shaders,” or simply “shaders.”

A variety of shading programs are directed at modeling illumination in a scene. The physical plausibility of rendered illumination often depends on the application, more specifically, whether or not the rendering is done in real-time. Physically plausible illumination at real-time frame rates is often achieved using approximations. For example, ambient occlusion is a popular approximation because of its high speed and simple implementation. Another example is directional occlusion. Many algorithms can only approximate direct illumination, which is light coming directly from a light source. Other shading programs are directed at camera effects, such as depth-of-field and motion blur.

Many shading programs are implemented as deferred shading. Deferred shading techniques have the advantage of decoupling scene geometry from the effects they implement. This simplifies the management and rendering of complex lighting found in many scenes. For example, screen-space ambient occlusion (SSAO) is a common deferred shading implementation that produces physically plausible lighting effects without a significant performance degradation.

### SUMMARY

One aspect provides a graphics processing subsystem, including: (1) a memory configured to store a buffer having a plurality of constants determinable upon execution of an application for which a scene is rendered, and (2) a central processing unit (CPU) operable to determine projection parameters from the buffer according to shader-reflection metadata attached to a programmable shader submitted for execution, and employ the projection parameters to cause an effect to be rendered on the scene by a graphics processing unit (GPU).

Another aspect provides a method of recovering projection parameters for rendering an effect, including: (1) extracting a matrix from a buffer according to shader-reflection metadata, (2) verifying the matrix contains data from which projection parameters are derived, and (3) employing the projection parameters in rendering the effect.

Yet another aspect provides a graphics processing system for rendering a scene and rendering an effect in three-dimensional space, including: (1) a memory configured to store a constant buffer, (2) a shader cache configured to store a plurality of programmable shaders having shader-reflection metadata that describes the constant buffer, (3) a CPU operable to: (3a) execute an application, thereby writing data based on projection parameters to the constant buffer and submitting the data and the plurality of programmable shaders to an application programming interface (API), and (3b) execute a device driver configured to employ the shader-reflection metadata to detect and recover the projection parameters from the data, and (4) a GPU configured to employ the projection parameters to render the effect.

### BRIEF DESCRIPTION

Reference is now made to the following descriptions taken in conjunction with the accompanying drawings, in which:

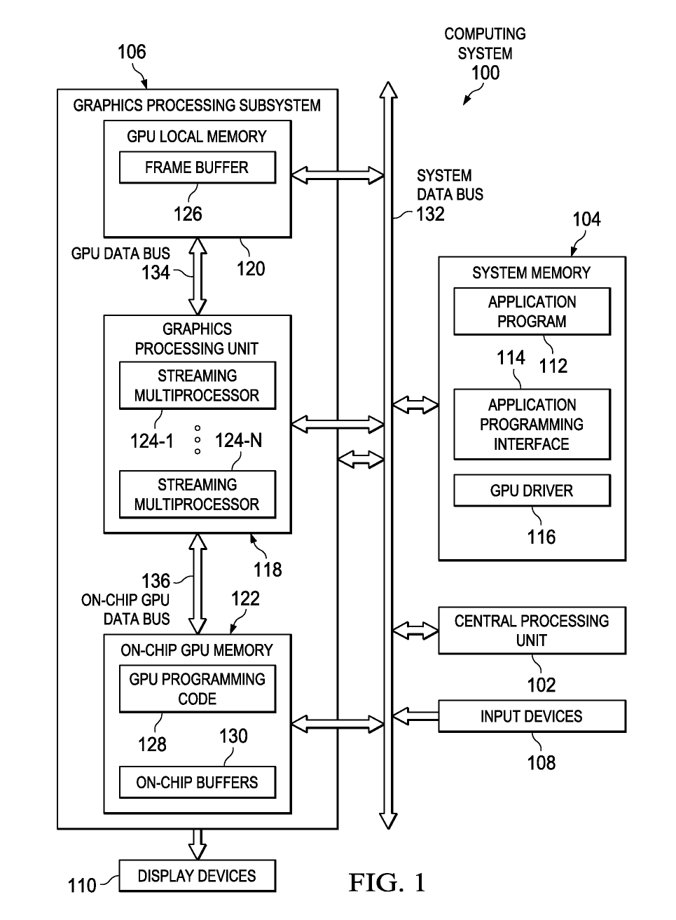

FIG. 1 is a block diagram of one embodiment of a computing system in which one or more aspects of the invention may be implemented;

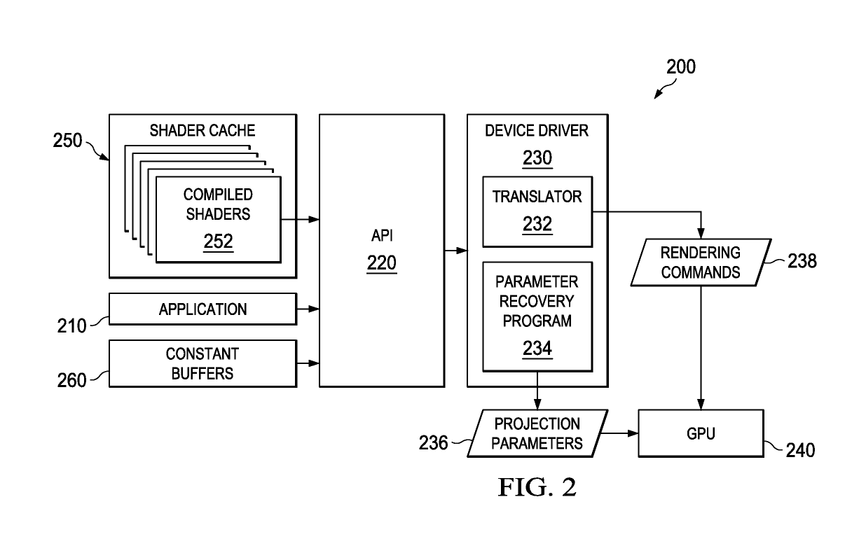

FIG. 2 is a block diagram of one embodiment of a graphics processing system for recovering projection parameters and using them for rendering effects;

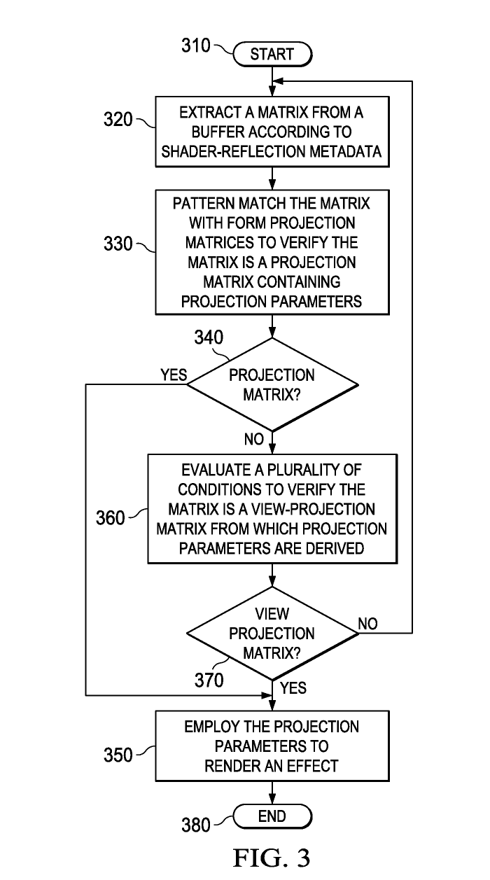

FIG. 3 is a flow diagram of one embodiment of a method of recovering projection parameters for rendering an effect.

### DETAILED DESCRIPTION

Many deferred shading programs operate on three-dimensional view-space positions. These positions are typically not available at deferred shading stages of a rendering pipeline because they are executed after geometry rendering, which is sometimes referred to as “post-processing.” A projection matrix is needed, in addition to a viewport, to reconstruct the three-dimensional view-space positions. The viewport is generally available through graphics APIs and is accessible by deferred shading programs. However, the projection matrix is not specifically available through graphics APIs, it is typically stored in constant buffers along with many other constants employed by various shading programs. Shading programs created with knowledge of the constant buffers can gain direct access to the constant buffers via references built into the shading programs. Other shading programs, often deferred shading programs built into the API for post-processing effects, are created without any references to the constant buffers. Consequently, the constant buffers appear to be compiled random data without any correlation to the constant values written to the constant buffer during execution of the main graphics application.

It is realized herein the projection matrix can be recovered from a constant buffer with the aid of shader-reflection metadata embedded in compiled shaders referencing that constant buffer. The compiled shaders are the shading programs created with knowledge of the constant buffers. Compiled shaders are typically compiled into a shader cache, from which they flow to a device driver through the API. Device drivers are typically hardware-dependent and created for a specific operating system. For example, a graphics device driver can be written for a specific GPU or family of GPUs. The graphics device driver executes on the CPU, translating compiled shaders and rendering commands, and communicates to the GPU over a communication bus to submit translated commands and receive whatever data the GPU submits back to the CPU. The device driver, or simply “driver,” is a body of code, or application that implements a device interface, or device driver interface (DDI), and executes on a CPU to translate the compiled shaders and other rendering commands to a binary code that can be executed by a GPU. The shader-reflection metadata is located in the header sections of the compiled shaders and may reference one or more constant buffers. Some applications, when compiled, strip away shader-reflection metadata from the compiled shaders. Other applications and other shader programs are compiled with the shader-reflection metadata intact.

Shader-reflection metadata describes the memory layout, or structure, of the constant buffers referenced by the various compiled shaders. Once a compiled shader is submitted through the API to the driver, it is realized herein, the driver can mine the shader-reflection metadata for information relevant to locating either a projection matrix or a view-projection matrix in the constant buffers referenced by the compiled shader. Shader-reflection metadata typically includes at least a constant buffer slot ID, an offset and a size for each constant. It is realized herein that based on this data, every constant buffer slot populated with an appropriately sized matrix can be located. For example, a 4×4 matrix may require a 64 byte memory block. In that case, offset values are noted for each constant buffer slot populated with a 64 byte size. The driver can then check whether each candidate 4×4 matrix is a projection matrix or a view-projection matrix.

A projection matrix, P, is a 4×4 matrix. A projection matrix typically consists of zeros, non-zeros and a plus-or-minus one. Depending on the source application for the projection matrix, the structure of the matrix may take one of several forms. The projection matrix can be expressed in terms of projection parameters. Projection parameters include depth-near (z-near), depth-far (z-far), viewport height, viewport width, field-of-view (FOV) and aspect ratio. The plus-or-minus one term specifies whether the coordinate system is left-handed (+1) or right-handed (−1). Below are several form projection matrices:

$$Left \text{-} Handed \text{:} [ \begin{matrix}2 \frac{{z}_{n}}{w} & 0 & 0 & 0 \\ 0 & 2 \frac{{z}_{n}}{h} & 0 & 0 \\ 0 & 0 & \frac{{z}_{f}}{{z}_{f} - {z}_{n}} & 1 \\ 0 & 0 & \frac{{z}_{n} {z}_{f}}{{z}_{n} - {z}_{f}} & 0\end{matrix} ] , \\ R ight \text{-} Handed \text{:} [ \begin{matrix}2 \frac{{z}_{n}}{w} & 0 & 0 & 0 \\ 0 & 2 \frac{{z}_{n}}{h} & 0 & 0 \\ 0 & 0 & \frac{{z}_{f}}{{z}_{f} - {z}_{n}} & - 1 \\ 0 & 0 & \frac{{z}_{n} {z}_{f}}{{z}_{n} - {z}_{f}} & 0\end{matrix} ] , \\ FOV Left \text{-} Handed \text{:} [ \begin{matrix}\frac{cot ( \frac{{FOV}_{Y}}{2} )}{aspect ratio} & 0 & 0 & 0 \\ 0 & cot ( \frac{{FOV}_{Y}}{2} ) & 0 & 0 \\ 0 & 0 & \frac{{z}_{f}}{{z}_{f} - {z}_{n}} & 1 \\ 0 & 0 & \frac{{z}_{n} {z}_{f}}{{z}_{n} - {z}_{f}} & 0\end{matrix} ] , \\ and$$

$$FOV R ight \text{-} Handed \text{:} [ \begin{matrix}\frac{cot ( \frac{{FOV}_{Y}}{2} )}{aspect ratio} & 0 & 0 & 0 \\ 0 & cot ( \frac{{FOV}_{Y}}{2} ) & 0 & 0 \\ 0 & 0 & \frac{{z}_{f}}{{z}_{f} - {z}_{n}} & - 1 \\ 0 & 0 & \frac{{z}_{n} {z}_{f}}{{z}_{n} - {z}_{f}} & 0\end{matrix} ] ,$$

where

w is viewport width,

h is viewport height,

FOV_{Y} is field-of-view in the Y dimension,

zₙ is depth-near, or z-near,

And z_{f} is depth-far, or z-far.

A view-projection matrix, PV, is also a 4×4 matrix. The projection parameters of the projection matrix can be derived from the terms of the view-projection matrix, PV, as the view-projection matrix is the matrix multiplication of the projection matrix and a view matrix, V. The view matrix is expressed in terms of a rotation matrix, R, a translation matrix, p, and a uniform scaling constant, α.

$$V = [ \begin{matrix}R & p \\ 0 & 1\end{matrix} ] [ \begin{matrix}α I & 0 \\ 0 & 1\end{matrix} ] , where$$

$$R = [ \begin{matrix}{r}_{00} & {r}_{01} & {r}_{02} \\ {r}_{10} & {r}_{11} & {r}_{12} \\ {r}_{20} & {r}_{21} & {r}_{22}\end{matrix} ] = [ \begin{matrix}{r}_{0}^{T} \\ {r}_{1}^{T} \\ {r}_{2}^{T}\end{matrix} ] , p = [ \begin{matrix}{p}_{0} \\ {p}_{1} \\ {p}_{2}\end{matrix} ] , \\ P = [ \begin{matrix}{a}_{0} & 0 & {a}_{02} & 0 \\ 0 & {a}_{1} & {a}_{12} & 0 \\ 0 & 0 & a & b \\ 0 & 0 & s & 1\end{matrix} ] = [ \begin{matrix}Q & be \\ {se}^{T} & 1\end{matrix} ] , \\ Q = [ \begin{matrix}{a}_{0} & 0 & {a}_{02} \\ 0 & {a}_{1} & {a}_{12} \\ 0 & 0 & a\end{matrix} ] , e = [ \begin{matrix}0 \\ 0 \\ 1\end{matrix} ] , s = \pm 1.$$

$$PV = [ \begin{matrix}Q & be \\ {se}^{T} & 1\end{matrix} ] [ \begin{matrix}R & p \\ 0 & 1\end{matrix} ] [ \begin{matrix}α I & 0 \\ 0 & 1\end{matrix} ]$$

A candidate matrix assumes the following form:

$${C}_{CB} = [ \begin{matrix}{c}_{00} & {c}_{00} & {c}_{00} & {c}_{00} \\ {c}_{10} & {c}_{11} & {c}_{12} & {c}_{13} \\ {c}_{20} & {c}_{21} & {c}_{22} & {c}_{23} \\ {c}_{30} & {c}_{31} & {c}_{32} & {c}_{33}\end{matrix} ] = [ \begin{matrix}A & B \\ C & D\end{matrix} ] , \\ A = [ \begin{matrix}{c}_{00} & {c}_{01} & {c}_{02} \\ {c}_{10} & {c}_{11} & {c}_{12} \\ {c}_{20} & {c}_{21} & {c}_{22}\end{matrix} ] , B = [ \begin{matrix}{c}_{03} \\ {c}_{13} \\ {c}_{23}\end{matrix} ] , C = [ \begin{matrix}{c}_{30} \\ {c}_{31} \\ {c}_{32}\end{matrix} ] , D = {c}_{33} .$$

If the candidate matrix is a view-projection matrix, then PV=C_{CB},

$$\begin{matrix}[ \begin{matrix}A & B \\ C & D\end{matrix} ] = [ \begin{matrix}Q & be \\ {se}^{T} & 1\end{matrix} ] [ \begin{matrix}R & p \\ 0 & 1\end{matrix} ] [ \begin{matrix}α I & 0 \\ 0 & 1\end{matrix} ] \\ = [ \begin{matrix}Q & be \\ {se}^{T} & 1\end{matrix} ] [ \begin{matrix}α R & p \\ 0 & 1\end{matrix} ] \\ = [ \begin{matrix}α QR & Qp + be \\ α {sr}_{2}^{T} & {sp}_{3}\end{matrix} ] .\end{matrix}$$

Thus, if A=αQR, B=Qp+be, C=αsr₂^{T}, and D=sp₃ for a valid set of α, Q, R, p, b, and s, then C_{CB} is a view-projection matrix.

First, it is known that C^{T}C=α²s²r₂^{T}r₂=α² where α is the uniform scaling constant is most often one, which is the basis for a first condition: C^{T}C=1.

Next, A is expanded:

$$A = α QR = α [ \begin{matrix}{a}_{0} & 0 & {a}_{02} \\ 0 & {a}_{1} & {a}_{12} \\ 0 & 0 & a\end{matrix} ] [ \begin{matrix}{r}_{0}^{T} \\ {r}_{1}^{T} \\ {r}_{2}^{T}\end{matrix} ] = α [ \begin{matrix}{a}_{0} {r}_{0}^{T} + {a}_{02} {r}_{2}^{T} \\ {a}_{1} {r}_{1}^{T} + {a}_{12} {r}_{2}^{T} \\ {ar}_{2}^{T}\end{matrix} ] ,$$

Which allows the computation of AC^{T}:

$${AC}^{T} = α [ \begin{matrix}{a}_{0} {r}_{0}^{T} + {a}_{02} {r}_{2}^{T} \\ {a}_{1} {r}_{1}^{T} + {a}_{12} {r}_{2}^{T} \\ {ar}_{2}^{T}\end{matrix} ] α {sr}_{2} = {α}^{2} s [ \begin{matrix}{a}_{02} \\ {a}_{12} \\ a\end{matrix} ] .$$

Given that a≠0, a second condition is determined: AC^{T}e=α²sa≠0.

Next, define a matrix G in terms of matrices A and C,

$$G ≡ A - \frac{1}{{α}^{2} {s}^{2}} {AC}^{T} C ,$$

which expands to the following:

$$G = α [ \begin{matrix}{a}_{0} {r}_{0}^{T} + {a}_{02} {r}_{2}^{T} \\ {a}_{1} {r}_{1}^{T} + {a}_{12} {r}_{2}^{T} \\ {ar}_{2}^{T}\end{matrix} ] - \frac{1}{{α}^{2} {s}^{2}} {α}^{2} s [ \begin{matrix}{a}_{02} \\ {a}_{12} \\ a\end{matrix} ] α {sr}_{2}^{T} = α [ \begin{matrix}{a}_{0} {r}_{0}^{T} \\ {a}_{1} {r}_{1}^{T} \\ 0 \; 0 \; 0\end{matrix} ] .$$

From this expansion of G, the remaining conditions are derived:

$${row}_{2} ( G ) = {e}^{T} ( A - \frac{1}{{α}^{2} {s}^{2}} {AC}^{T} C ) = [ \begin{matrix}0 & 0 & 0\end{matrix} ] ,$$

Where rowᵢ(G) is the i^{th} row of G. The rows of the rotation matrix, R, which represent vectors, are orthogonal to each other, meaning r₀ is orthogonal to r₂, r₁ is orthogonal to r₂ and r₀ is orthogonal to r₁. Additionally, because C=αsr₂^{T}, vector C is parallel to vector r₂, and orthogonal to both r₀ and r₁. Given the multiplication, or dot product, of two orthogonal vectors is zero, that row₀(G) is parallel to r₀ and row₁(G) is parallel to r₁ the following three conditions are derived:

row₀(G)C^{T}=0,

row₁(G)C^{T}=0, and

row₀(G)^{T}row₁(G)=αa₀r₀^{T}αa₁r₁=0.

Additionally, given that a₀ and a₁ are non-zero, two more conditions are determined:

$${a}_{0}^{2} = \frac{{{row}_{0} ( G )}^{T} {row}_{0} ( G )}{{C}^{T} C} \neq 0 , and$$

$${a}_{1}^{2} = \frac{{{row}_{1} ( G )}^{T} {row}_{1} ( G )}{{C}^{T} C} \neq 0.$$

It is realized herein that if a candidate matrix from the constant buffer matches one of the form projection matrices above, then the candidate matrix is a projection matrix and can be used by the GPU in executing deferred shading programs. It is also realized herein that if a candidate matrix from the constant buffer satisfies the conditions above, then the candidate matrix is a view-projection matrix from which projection parameters can be derived. For example,

$${a}_{0} = \sqrt{\frac{{{row}_{0} ( G )}^{T} {row}_{0} ( G )}{{C}^{T} C}} , \\ {a}_{1} = \sqrt{\frac{{{row}_{1} ( G )}^{T} {row}_{1} ( G )}{{C}^{T} C}} , \\ a = \frac{{e}^{T} {AC}^{T}}{s {α}^{2}} = \frac{{e}^{T} {AC}^{T}}{s {C}^{T} C} , \\ {z}_{f} = \frac{b}{1 - as} and {z}_{n} = - \frac{b}{as} , \\ as = \frac{{e}^{T} {AC}^{T}}{{C}^{T} C} , and b = {e}^{T} ( B - \frac{D}{{C}^{T} C} {AC}^{T} ) , \\ where e = [ {\begin{matrix}0 & 0 & 1 ]\end{matrix}}^{T} .$$

Additionally, the aspect ratio and field-of-view are computed as:

$$aspect ratio = \frac{viewport width}{viewport height} = \frac{w}{h} = \frac{{a}_{1}}{{a}_{0}} , and$$

$$FOV = 2 atan ( \frac{\frac{h}{2}}{{z}_{near}} ) = 2 atan ( \frac{1}{{a}_{1}} ) .$$

These projection parameters form the necessary projection matrix used by the GPU in executing deferred shading programs. These deferred shading programs may be invoked by the main graphics application via rendering commands through the API, or independent of the main graphics application and rendering commands. For example, a user may select a configuration of the graphics processing system to process deferred shading effects in addition to those invoked by the main graphics application.

Before describing various embodiments of the graphics processing subsystem or method of recovering projection parameters introduced herein, a computing system within which various aspects of the invention may be embodied or carried out will be described.

FIG. 1 is a block diagram of one embodiment of a computing system 100 in which one or more aspects of the invention may be implemented. The computing system 100 includes a system data bus 132, a central processing unit (CPU) 102, input devices 108, a system memory 104, a graphics processing subsystem 106, and display devices 110. In alternate embodiments, the CPU 102, portions of the graphics processing subsystem 106, the system data bus 132, or any combination thereof, may be integrated into a single processing unit. Further, the functionality of the graphics processing subsystem 106 may be included in a chipset or in some other type of special purpose processing unit or co-processor.

As shown, the system data bus 132 connects the CPU 102, the input devices 108, the system memory 104, and the graphics processing subsystem 106. In alternate embodiments, the system memory 100 may connect directly to the CPU 102. The CPU 102 receives user input from the input devices 108, executes programming instructions stored in the system memory 104, operates on data stored in the system memory 104, and configures the graphics processing subsystem 106 to perform specific tasks in the graphics pipeline. The system memory 104 typically includes dynamic random access memory (DRAM) employed to store programming instructions and data for processing by the CPU 102 and the graphics processing subsystem 106. The graphics processing subsystem 106 receives instructions transmitted by the CPU 102 and processes the instructions in order to render and display graphics images on the display devices 110.

As also shown, the system memory 104 includes an application program 112, an application programming interface (API) 114, and a graphics processing unit (GPU) driver 116. The application program 112 generates calls to the API 114 in order to produce a desired set of results, typically in the form of a sequence of graphics images. The application program 112 also transmits zero or more high-level shading programs to the API 114 for processing within the GPU driver 116. The high-level shading programs are typically source code text of high-level programming instructions that are designed to operate on one or more shading engines within the graphics processing subsystem 106. The API 114 functionality is typically implemented within the GPU driver 116. The GPU driver 116 is configured to translate the high-level shading programs into machine code shading programs that are typically optimized for a specific type of shading engine (e.g., vertex, geometry, or fragment).

The graphics processing subsystem 106 includes a graphics processing unit (GPU) 118, an on-chip GPU memory 122, an on-chip GPU data bus 136, a GPU local memory 120, and a GPU data bus 134. The GPU 118 is configured to communicate with the on-chip GPU memory 122 via the on-chip GPU data bus 136 and with the GPU local memory 120 via the GPU data bus 134. The GPU 118 may receive instructions transmitted by the CPU 102, process the instructions in order to render graphics data and images, and store these images in the GPU local memory 120. Subsequently, the GPU 118 may display certain graphics images stored in the GPU local memory 120 on the display devices 110.

The GPU 118 includes one or more streaming multiprocessors 124. Each of the streaming multiprocessors 124 is capable of executing a relatively large number of threads concurrently. Advantageously, each of the streaming multiprocessors 124 can be programmed to execute processing tasks relating to a wide variety of applications, including but not limited to linear and nonlinear data transforms, filtering of video and/or audio data, modeling operations (e.g., applying of physics to determine position, velocity, and other attributes of objects), and so on. Furthermore, each of the streaming multiprocessors 124 may be configured as a shading engine that includes one or more programmable shaders, each executing a machine code shading program (i.e., a thread) to perform image rendering operations. The GPU 118 may be provided with any amount of on-chip GPU memory 122 and GPU local memory 120, including none, and may employ on-chip GPU memory 122, GPU local memory 120, and system memory 104 in any combination for memory operations.

The on-chip GPU memory 122 is configured to include GPU programming code 128 and on-chip buffers 130. The GPU programming 128 may be transmitted from the GPU driver 116 to the on-chip GPU memory 122 via the system data bus 132. The GPU programming 128 may include a machine code vertex shading program, a machine code geometry shading program, a machine code fragment shading program, or any number of variations of each. The on-chip buffers 130 are typically employed to store shading data that requires fast access in order to reduce the latency of the shading engines in the graphics pipeline. Since the on-chip GPU memory 122 takes up valuable die area, it is relatively expensive.

The GPU local memory 120 typically includes less expensive off-chip dynamic random access memory (DRAM) and is also employed to store data and programming employed by the GPU 118. As shown, the GPU local memory 120 includes a frame buffer 126. The frame buffer 126 stores data for at least one two-dimensional surface that may be employed to drive the display devices 110. Furthermore, the frame buffer 126 may include more than one two-dimensional surface so that the GPU 118 can render to one two-dimensional surface while a second two-dimensional surface is employed to drive the display devices 110.

The display devices 110 are one or more output devices capable of emitting a visual image corresponding to an input data signal. For example, a display device may be built using a cathode ray tube (CRT) monitor, a liquid crystal display, or any other suitable display system. The input data signals to the display devices 110 are typically generated by scanning out the contents of one or more frames of image data that is stored in the frame buffer 126.

Having described a computing system within which various aspects of the graphics processing subsystem or method of recovering projection parameters may be embodied or carried out, several embodiments of the graphics processing subsystem and method of recovering projection parameters will be described.

FIG. 2 is a block diagram of one embodiment of a graphics processing system 200. System 200 includes an application 210, an API 220, a device driver 230, a GPU 240, a shader cache 250 and a constant buffers 260.

Application 210 is stored in system memory and executes on a CPU. During execution, application 210 generates and describes a scene to be rendered by system 200 by submitting scene data, which is operated on during rendering, and function calls to API 220. Function calls submitted by application 210 invoke shader programs compiled to shader cache 250, or compiled shaders 252. Compiled shaders 252 are also submitted to API 220. Among the data submitted to API 220, application 210 may submit certain pieces of data explicitly, while other data is written to constant buffers 260, which are allocated in system memory. Values written to constant buffers 260 can include a view matrix, a projection matrix, a view-projection matrix, and any combination of those matrices, among others. These matrices contain projection parameters and data for deriving projection parameters that are useful in reconstructing a two-dimensional scene in three-dimensional space. Projection parameters are parameters such as aspect ratio, field-of-view, z-near and z-far, among others. Compiled shaders 252 can reference these various pieces of data as needed.

API 220 directs submitted data and compiled shaders 252 to device driver 230. Device driver 230 is an application that runs on the CPU that serves as an interface between GPU 240 and the CPU, and its various applications, including application 210. Device driver 230 includes a translator 232 and a parameter recovery program 234. Translator 232 translates compiled shaders 252 to a binary code that can be executed by GPU 240. The binary code represents rendering commands 238. Rendering commands 238 operate on the scene data generated by application 210, sometimes referring to values written to constant buffers 260, also by application 210.

Some of rendering commands 238 are generated by device driver 230 without any reference to constant buffers 260. These rendering commands are generated due to an invocation of an effect built into device driver 230. Such an invocation may be made by application 210 or independent of application 210. Certain effects operate on three-dimensional view-space positions that are reconstructed from X-Y positions and depth data for the scene. Three-dimensional view-space positions are generated by application 210, but are reduced to the X-Y positions and depth data during geometry buffer (G-buffer) rendering. Reconstruction of the three-dimensional view-space positions is necessary for certain effects to be carried out after G-buffer rendering, otherwise referred to as deferred shading or post-processing. Certain effects, which rely on the three-dimensional view-space positions, include screen-space ambient occlusion, depth-of-field effects, motion blur, indirect lighting, and others.

The reconstruction requires the use of a projection matrix and projection parameters. The projection matrix and projection parameters necessary for this conversion to screen-space are values often written to constant buffers 260 by application 210. However, unlike compiled shaders 252, which have direct access to the various buffer slots of constant buffers 260, these rendering commands have no reference to constant buffers 260 and cannot directly retrieve the projection matrix and projection parameters. The necessary data is mixed in with a variety of constants in constant buffers 260, which may include a view-matrix, a projection matrix, a view-projection matrix, a view-port, screen size and many others.

Device driver 230 employs parameter recovery program 234 to retrieve the necessary data from constant buffers 260. Parameter recovery program 234 gains access to compiled shaders 252, which are otherwise translated by translator 232. Parameter recovery program 234 employs shader-reflection metadata embedded in compiled shaders 252 to recover projection parameters 236 from constant buffers 260. Projection parameters 236 can then be used by GPU 240 to carry out rendering commands 238.

Shader-reflection metadata embedded in a compiled shader describes the layout, or structure of a reference constant buffer. Shader-reflection metadata is sometimes referred to as being a header section of a compiled shader. The shader-reflection metadata embedded in compiled shaders 252 describes the structure of constant buffers 260. The shader-reflection metadata typically includes at least a constant buffer slot ID, an offset and a size for each constant in the buffers. In some cases, shader-reflection metadata is stripped away from compiled shaders 252 when compiled to shader cache 250, in which case parameter recovery program 234 takes additional measures to recovery projection parameters 236.

Parameter recovery program 234, initiated by a “draw call” employs the shader-reflection metadata of a compiled shader first by identifying each slot in one of constant buffers 260 that is described by the shader-reflection metadata as having the appropriate size of a projection matrix or a view-projection matrix. For example, a 4×4 matrix may be stored in a 64 byte block of a constant buffer. In certain circumstances, there may be no 4×4 matrices written to the constant buffer for a particular draw call. In those circumstances, parameter recovery program 234 recovers no matrix and moves on to the next draw call to inspect other shader-reflection metadata describing another of constant buffers 260 or shader-reflection metadata of another compiled shader. In cases where shader-reflection metadata is unavailable, parameter recovery program 234 may fall back to a “brute-force” method of scanning constant buffers 260 for all appropriately sized slots.

Given at least one candidate 4×4 matrix described by the shader-reflection metadata, parameter recovery program 234 then gains access to however many 4×4 matrices are stored in constant buffer 260s by employing the offset for the respective buffer slots to address the system memory. Parameter recovery program 234 then evaluates each 4×4 matrix to determine if it is either a projection matrix or a view-projection matrix.

To evaluate whether a matrix is a projection matrix, parameter recovery program 234 uses pattern matching to compare the candidate matrix to form projection matrices. A form projection matrix is a generalized matrix that assumes a particular structure with respect to the locations of zeros, non-zeros and a plus-or-minus one. In certain embodiments, the pattern matching is performed for each form projection matrix and its transpose. If a match is found, the candidate 4×4 matrix is a projection matrix and contains projection parameters 236.

To evaluate whether a matrix is a view-projection matrix, parameter recovery program 234 checks several multivariable conditions that hold true for a view-projection matrix. Assuming the candidate 4×4 matrix takes the form of

$${C}_{CB} = [ \begin{matrix}{c}_{00} & {c}_{00} & {c}_{00} & {c}_{00} \\ {c}_{10} & {c}_{11} & {c}_{12} & {c}_{13} \\ {c}_{20} & {c}_{21} & {c}_{22} & {c}_{23} \\ {c}_{30} & {c}_{31} & {c}_{32} & {c}_{33}\end{matrix} ] = [ \begin{matrix}A & B \\ C & D\end{matrix} ] , \\ where , \\ A = [ \begin{matrix}{c}_{00} & {c}_{01} & {c}_{02} \\ {c}_{10} & {c}_{11} & {c}_{12} \\ {c}_{20} & {c}_{21} & {c}_{22}\end{matrix} ] , B = [ \begin{matrix}{c}_{03} \\ {c}_{13} \\ {c}_{23}\end{matrix} ] , C = [ \begin{matrix}{c}_{30} \\ {c}_{31} \\ {c}_{32}\end{matrix} ] , D = {c}_{33} , \\ And$$

$$\begin{matrix}[ \begin{matrix}A & B \\ C & D\end{matrix} ] = [ \begin{matrix}Q & be \\ {se}^{T} & 1\end{matrix} ] [ \begin{matrix}R & p \\ 0 & 1\end{matrix} ] [ \begin{matrix}α I & 0 \\ 0 & 1\end{matrix} ] \\ = [ \begin{matrix}Q & be \\ {se}^{T} & 1\end{matrix} ] [ \begin{matrix}α R & p \\ 0 & 1\end{matrix} ] \\ = [ \begin{matrix}α QR & Qp + be \\ α {sr}_{2}^{T} & {sp}_{3}\end{matrix} ] .\end{matrix}$$

The conditions evaluated according to matrix recovery program include:

$${C}^{T} C = 1 , \\ {AC}^{T} e = {α}^{2} sa \neq 0 , \\ {row}_{2} ( G ) = {e}^{T} ( A - \frac{1}{{α}^{2} {s}^{2}} {AC}^{T} C ) = [ \begin{matrix}0 & 0 & 0\end{matrix} ] , \\ {row}_{0} ( G ) {C}^{T} = 0 , \\ {row}_{1} ( G ) {C}^{T} = 0 , \\ {{row}_{0} ( G )}^{T} {row}_{1} ( G ) = α {a}_{0} {r}_{0}^{T} α {a}_{1} {r}_{1} = 0 , \\ {a}_{0}^{2} = \frac{{{row}_{0} ( G )}^{T} {row}_{0} ( G )}{{C}^{T} C} \neq 0 , and$$

$${a}_{1}^{2} = \frac{{{row}_{1} ( G )}^{T} {row}_{1} ( G )}{{C}^{T} C} \neq 0.$$

If the conditions hold true, then the candidate matrix is a view-projection matrix from which projection parameters 236 can be derived. Projection parameters 236 can then be employed by device driver 230 in generating rendering commands 238 or by GPU 240 in executing rendering commands 238 further down the rendering pipeline.

FIG. 3 is a flow diagram of one embodiment for a method of recovering projection parameters for rendering an effect. The method begins at a start step 310. At an extraction step 320, a matrix is extracted from a buffer according to shader-reflection metadata. The buffer is populated with the matrix upon the execution of an application. The application is responsible for generating scene data and rendering commands to be carried out for rendering a scene. The shader-reflection metadata describes the layout, or structure of the buffer such that populated 4×4 matrices can be identified. Shader-reflection metadata typically includes a buffer slot ID, an offset and a size for each buffer slot. The shader-reflection metadata is parsed to find populated buffer slots having the appropriate size of a 4×4 matrix.

At a projection evaluation step 330, the extracted matrix is pattern matched with form projection matrices to verify whether the extracted matrix is a projection matrix. At a step 340, a determination is made as to whether the extracted matrix is a projection matrix and it contains projection parameters. If not, the method proceeds to a view-projection evaluation step 360.

At view-projection evaluation step 360, the extracted matrix is evaluated against several conditions to verify whether the extracted matrix is a view-projection matrix. At a step 370, a determination is made as to whether the extracted matrix is a view-projection matrix containing data from which projection parameters can be derived. If not, the method returns to extraction step 320 to extract another matrix from the buffer.

If the extracted matrix is a projection matrix containing projection parameters, which is determined at step 340, or a view-projection matrix from which projection parameters can be derived, which is determined at step 370, the method proceeds to a rendering step 350.

In alternate embodiments, if a buffer slot is identified and a matrix extracted that is either a view-projection matrix or a projection matrix, the memory location for that buffer slot is stored. The next time a matrix needs to be extracted, the stored memory location is checked. If a 4×4 matrix is populated in that buffer slot, it is evaluated according to projection evaluation step 330 and view-projection evaluation step 360 to determine if it is a projection matrix or a view-projection matrix. This saves processing time by bypassing the analysis of shader-reflection metadata.

Once projection parameters are recovered from the buffer via projection evaluation step 330 or view-projection evaluation step 360, they are employed at rendering step 350 to render an effect on the rendered scene. The method then ends at an end step 380.

Those skilled in the art to which this application relates will appreciate that other and further additions, deletions, substitutions and modifications may be made to the described embodiments.

What is claimed is:

1. A graphics processing subsystem, comprising:
a memory configured to store a buffer having a plurality of constants determinable upon execution of an application for which a scene is rendered; and
a central processing unit (CPU) operable to determine projection parameters from said buffer according to shader-reflection metadata attached to a programmable shader submitted for execution, and employ said projection parameters to cause an effect to be rendered on said scene by a graphics processing unit (GPU).

2. The graphics processing subsystem recited in claim 1 wherein said application is executable by said CPU and is configured to submit scene data and said programmable shader to said GPU for rendering said scene.

3. The graphics processing subsystem recited in claim 1 wherein said projection parameters include depth-near (z-near) and depth-far (z-far).

4. The graphics processing subsystem recited in claim 1 wherein said projection parameters include vertical field of view angle.

5. The graphics processing subsystem recited in claim 1 wherein said effect is screen-space ambient occlusion (SSAO).

6. The graphics processing subsystem recited in claim 1 wherein said effect is a depth-of-field effect.

7. The graphics processing subsystem recited in claim 1 wherein said plurality of constants includes a view-projection matrix.

8. The graphics processing subsystem recited in claim 1 wherein said CPU is further operable to recover a projection matrix from said buffer.

9. The graphics processing subsystem recited in claim 1 wherein said shader-reflection metadata includes a description of the structure of said buffer in said memory.

10. A method of recovering projection parameters for rendering an effect, comprising:
extracting a matrix from a buffer according to shader-reflection metadata;
verifying said matrix contains data from which projection parameters are derived; and
employing said projection parameters in rendering said effect.

11. The method recited in claim 10 wherein said shader-reflection metadata includes an offset and size for each slot in said buffer.

12. The method recited in claim 10 wherein said matrix is a projection matrix containing said projection parameters.

13. The method recited in claim 10 wherein said matrix is a view-projection matrix from which said projection parameters can be derived.

14. The method recited in claim 10 wherein said verifying includes pattern matching said matrix with form projection matrices.

15. The method recited in claim 10 wherein said verifying includes evaluating a plurality of conditions.

16. The method recited in claim 15 wherein said plurality of conditions are in terms of a rotation matrix, a translation matrix, and a uniform scaling constant.

17. A graphics processing system for rendering a scene and rendering an effect in three-dimensional space, comprising:
a memory configured to store a constant buffer;
a shader cache configured to store a plurality of programmable shaders having shader-reflection metadata that describes said constant buffer;
a central processing unit (CPU) operable to:
execute an application, thereby writing data based on projection parameters to said constant buffer and submitting said data and said plurality of programmable shaders to an application programming interface (API), and
execute a device driver configured to employ said shader-reflection metadata to detect and recover said projection parameters from said data; and
a graphics processing unit (GPU) configured to employ said projection parameters to render said effect.

18. The graphics processing system recited in claim 17 wherein said shader-reflection metadata includes buffer slot identifications, buffer slot sizes and buffer slot offsets.

19. The graphics processing system recited in claim 17 wherein said device driver includes a parameter recovery program configured to:
employ said shader-reflection metadata to identify appropriately sized buffer slots and extract respective matrices of data within;
evaluate said respective matrices against a plurality of conditions for identifying a view-projection matrix until a matrix is found that satisfies said plurality of conditions and from which said projection parameters can be recovered.

20. The graphics processing system recited in claim 19 wherein said parameter recovery program is further configured to remember a constant buffer location containing data from which said projection parameters are recovered, for use in recovering other projection parameters for subsequent frames of said scene.

21. The graphics processing system recited in claim 19 wherein said parameter recovery program is further configured to carry out pattern matching of said respective matrices with form projection matrices until a matrix is found from which said projection parameters can be recovered.

22. The graphics processing system recited in claim 17 wherein said GPU is further configured to employ said projection parameters to reconstruct three-dimensional view-space positions for rendering said effect.

23. The graphics processing system recited in claim 17 wherein said plurality of programmable shaders is a plurality of vertex shaders.
